(19) United States
(12) Patent Application Publication
(10) Pub. No.: US 2010/0111693 A1
(43) Pub. Date: May 6, 2010

(54) WIND TURBINE DAMPING OF TOWER RESONANT MOTION AND SYMMETRIC BLADE MOTION USING ESTIMATION METHODS

(76) Inventor: Kitchener Clark Wilson, Santa Barbara, CA (US)

Correspondence Address: FAY SHARPE LLP, 1228 Euclid Avenue, 5th Floor, The Halle Building, Cleveland, OH, 44115, US

(21) Appl. No.: 12/517,411

(22) PCT Filed: Jun. 18, 2007
(86) PCT No.: PCT/IB07/01875

§ 371 Date: Jun. 3, 2009

Related U.S. Application Data
(60) Provisional application No. 60/878,042, filed on Dec. 28, 2006.

(51) Int. Cl. F03D 7/02; F03D 11/04

(52) U.S. Cl. 416/1; 416/31

(57) ABSTRACT

A method for wind turbine tower load control includes controlling the pitch of the rotor blades in a conventional manner by a collective command component. An estimator estimates the tower resonant acceleration and the thrice-per-revolution blade imbalance acceleration. Combining logic, connected to the estimated resonant acceleration and to the estimated thrice-per-revolution (3P) acceleration provides a combined pitch modulation to damp the tower resonant motion and the thrice-per-revolution motion using collective modulation. The pitch modulation is combined with the collective command component to drive the pitch actuators.

### CROSS-REFERENCE TO RELATED APPLICATIONS

This application is related to U.S. Patent Application No. 60/849,160 of Kitchener Clark Wilson, William Erdman and Timothy J. McCoy entitled “Wind Turbine With Blade Pitch Control To Compensate For Wind Shear And Wind Misalignment” filed Oct. 2, 2006, which is assigned to Clipper Windpower Technology, Inc. and is incorporated herein by reference.

### BACKGROUND OF THE INVENTION

The invention relates to tower structures, such as wind turbine towers and more particularly to damping the turbine primary resonant frequencies by modulating the blade pitch angle while maintaining rated torque or power.

### DESCRIPTION OF THE PRIOR ART

Large modern wind turbines have rotor diameters of up to 100 meters with towers of a height to accommodate them. In the US tall towers are being considered for some places, such as the American Great Plains, to take advantage of estimates that doubling tower height will increase the wind power available by 45%.

Various techniques are in use, or proposed for use, to control a wind turbine. The goal of these control methodologies is to maximize electrical power generation while minimizing the mechanical loads imposed on the various turbine components. Loads cause stress and strain and are the source of fatigue failures that shorten the lifespan of components. Reducing loads allows the use of lighter or smaller components, an important consideration given the increasing sizes of wind turbines. Reducing loads also allows the use of the same components in higher power turbines to handle the increased wind energy or allows an increase in rotor diameter for the same rated power.

Wind turbines, and the towers that support them, have complex dynamics influenced by the wind activity as well as control inputs. The dynamics include rotor rpm, lightly damped tower motion, lightly damped drive train motion, flexible blade bending, etc. Wind turbine control is a balancing act between providing good control of the turbine rpm, adding tower motion damping, and adding drive train damping while minimizing or not exacerbating blade bending. State space control, with complex models of all these dynamics, hold promise to accomplish this, but such controls are complex and difficult to develop.

It is desirable to provide a control method that adds tower damping by modulating the rpm control pitch commands generated by conventional control methods (e.g. proportional-integral-PI compensators). Such a method is adaptable to inclusion in state space control algorithms as well as used as an adjunct to conventional controls.

Approaches to damping, for example tower damping, generally consist of measuring tower acceleration, detecting the natural tower resonant mode within that acceleration, and generating a feedback blade pitch that adds damping. U.S. Pat. Nos. 4,420,692 and 4,435,647 disclose the use of conventional band-pass filters applied to damp the tower first bending moment through use of blade pitch control. This type of damping in many situations increases blade bending motion, which is unacceptable

The acceleration signal has superimposed onto the natural tower resonant motion, among others, an acceleration due to the three-per-revolution (3P) force caused by imbalances and blade aerodynamic nonlinearities. Not eliminating some of these components from the pitch-feedback-damping signal can aggravate blade motion and lead to blade fatigue and failure. In particular, the 3P signal picked up by the tower accelerometer 144 used for damping is very close to the tower resonant frequency and within the pass-band of the band-pass filters disclosed in U.S. Pat. Nos. 4,420,692 and 4,435,647. Using the band-pass filters results in the 3P signals being passed through to the blade pitch control with an arbitrary phase. The source of the 3P signal is the blade symmetric bending mode where all three rotor blades move together, bending in and out of the blade rotor disc plane. The 3P frequency component is close to the blade symmetric bending mode resonant frequency and, when passed through with phase changes caused by the band-pass filter, exacerbates the symmetric blade bending.

It is therefore desirable to provide a means to separate the tower resonant motion from that caused by 3P blade imbalance. Conventional approaches to eliminating a frequency component consist of placing a notch filter in series with the conventional band-pass filter. The 3P notch, being close in frequency to the band-pass, adds its phase and gain error to the final output making control difficult. This process does not produce estimates of the tower resonant motion and of the 3P motion.

It is desirable to provide estimates of the motion of the tower at its known resonant frequency using tower acceleration measurements alone. Such estimates, uncorrupted by other motions, are needed to generate pitch feedback signals for tower resonant motion damping.

It is also desirable to provide estimates of the 3P acceleration caused by the rotation of the three unbalanced blades. Such estimates uncorrupted by tower resonant motion and having selected phase so as not to exacerbate blade bending, are needed for tower and blade damping and general turbine control.

### SUMMARY OF THE INVENTION

Briefly, the present invention relates to an apparatus and method of controlling a wind turbine having a number of rotor blades comprising a method of using tower acceleration measurements to damp tower resonant motion, and to damp 3P motion and hence blade symmetric bending. The tower resonant acceleration is caused by the collective response of the tower and blades to the wind changes averaged over the entire blade disc. With three unbalanced blades rotating in a wind shear (vertical, horizontal or due to yaw misalignment), the interaction of the air stream with the blades is a thrice per revolution motion superimposed on the resonant motion. The resulting overall tower acceleration includes the lightly damped resonant motion of the tower structure with superimposed thrice per revolution activity. This tower motion causes fatigue failure and shortens the tower life.

Further, the blades themselves are elongated flexible structures having their own bending modes and resonant motion. As the pitch commands are actuated on these blades by turning them to and from a feather position, the blade bending is strongly influenced. If the pitch commands include a frequency component near the blade symmetric bending resonant frequency, the pitch activity can exacerbate blade bending and increase blade loading and shorten their life.

In accordance with an aspect of the invention, the wind turbine uses feedback pitch commands to control pitch of the blades in order to control the rpm of the rotor and the power generated by the turbine. The present invention adds, to this rpm controlling feedback pitch, a feedback component to damp the tower resonant motion that does not include frequencies that exacerbate blade bending. This tower resonant motion damping feedback pitch component is applied collectively (equally to each blade).

In accordance with an aspect of the invention, the present invention further adds a feedback pitch component that reduces the 3P tower motion and, therefore, blade bending. This 3P motion damping feedback pitch component is also applied collectively.

In accordance with an aspect of the invention, in order to damp the tower motion, the turbine control includes a means to estimate the tower resonant motion and simultaneously estimate the tower 3P motion. The control further produces a tower damping pitch feedback signal and a 3P damping pitch feedback pitch signal.

In accordance with an aspect of the invention, this is accomplished by an estimator using only the tower acceleration measurements and tuned to specifically estimate the tower resonant acceleration and simultaneously estimate the 3P tower acceleration. The resonant tower damping pitch feedback signal is formed from the estimated tower resonant acceleration rate, and the 3P pitch feedback signal is formed from the estimated 3P tower acceleration rate.

Further, to correct for pitch actuator and other turbine system lags, each feedback signal is provided with individual phase control to advance or retard each as needed. The 3P pitch feedback signal does not exacerbate the blade symmetric bending mode as its phase is set to mitigate this mode.

Further, to account for varying wind conditions, each feedback signal is provided with a gain that adapts to the condition.

The feedback signals are formed as modulations of the nominal pitch signals developed by the tower controls (state space, Proportional-Integral-Derivative-PID, . . . ) for rpm or other purposes. The final pitch command to the pitch actuator is the sum of the nominal, the resonant tower damping pitch modulation, and the 3P pitch feedback modulation.

In accordance with an aspect of the invention, acceleration caused by the 3P motion of the imbalanced blades is rejected in the tower resonant pitch feedback signal.

In accordance with an aspect of the invention, acceleration caused by the resonant motion of the tower is rejected in the 3P pitch feedback signal.

The invention has the advantage that it rids the tower resonant motion pitch control signal of 3P (or any other selected frequency) signal while passing the tower first bending frequency (or any other selected frequency). Further it rids the 3P pitch control signal of tower resonant motion (or any other selected frequency) signal while passing the 3P frequency (or any other selected frequency). Further it provides feedback pitch signals to mitigate the tower resonant motion and the 3P motion.

This holds true even when such frequencies are too close to use conventional frequency filters. Further, a method of introducing desired phase to compensate for actuator lags is included. Further, a method of gain adaptation to wind conditions is included. This is a very general and relatively simple technique that can be used to detect one frequency signal when another is close by and can be used advantageously for many purposes other than tower motion damping.

### BRIEF DESCRIPTION OF THE DRAWINGS

The invention and its mode of operation will be more fully understood from the following detailed description when taken with the appended drawings in which:

FIG. 1 is a block diagram of a variable speed wind turbine in accordance with the present invention highlighting the key turbine elements.

FIG. 2 is a block diagram of a tower damping system in accordance with the present invention.

FIG. 3 is a graphical display of the transfer function of the estimated tower resonant rate of acceleration driven by the tower-measured acceleration before parameter selection.

FIG. 4 is a graphical display of the transfer function of the estimated tower resonant rate of acceleration driven by the tower-measured acceleration after parameter selection.

FIG. 5 is a graphical display of a sample rate of acceleration sensitivity to the steady state pitch where the pitch is a stand-in for wind speed.

FIG. 6 is a graphical display of the transfer function of the pitch modulation to compensate for tower resonant acceleration driven by the tower measured acceleration after parameter selection and provision of adaptive gain (at wind speed of 14 m/s or 10.77 degree pitch).

FIG. 7 is a graphical display of the transfer function of the pitch modulation to compensate for tower resonant acceleration driven by the tower-measured acceleration after parameter selection and provision of adaptive gain (at wind speed of 14 m/s or 10.77 degree pitch) and addition of 30 degree phase lead.

FIG. 8 is a graphical display of the transfer function of a conventional band-pass and notch filter replication of FIG. 4 to illustrate the phase error introduced.

FIG. 9 is a graphical display of the transfer function of the estimated 3P rate of acceleration driven by the tower-measured acceleration after parameter selection.

FIG. 10 is a graphical display of the transfer function of the −30 degree phase shifted estimated 3P rate of acceleration driven by the tower-measured acceleration after parameter selection.

### DETAILED DESCRIPTION OF THE INVENTION

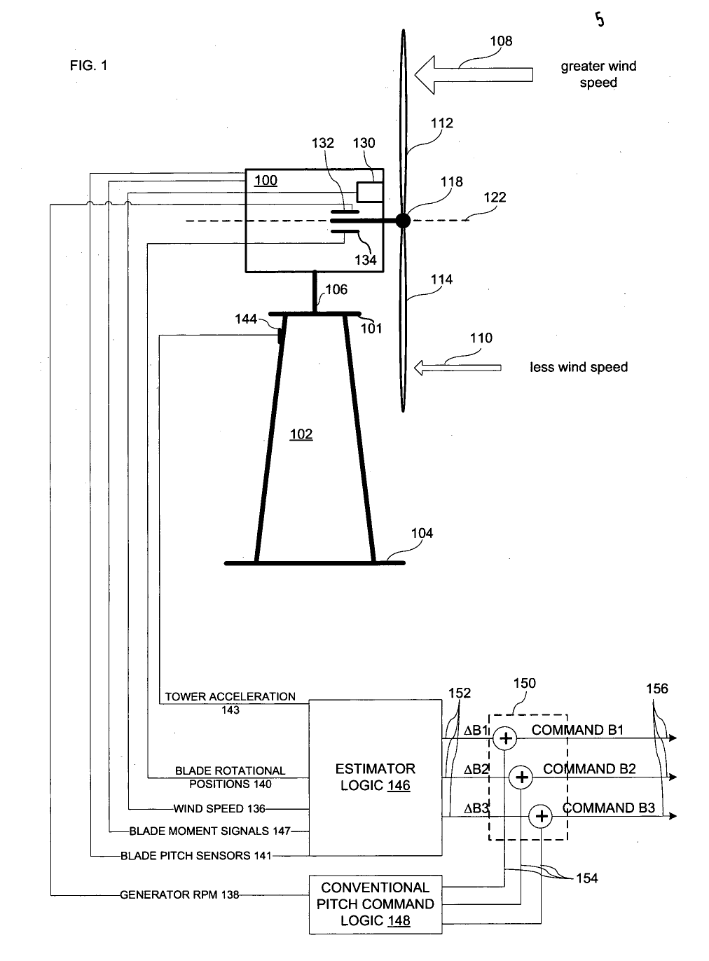

Refer to FIG. 1, which is a block diagram of a variable-speed wind turbine apparatus in accordance with the present invention. The wind-power generating device includes a turbine with one or more electric generators housed in a nacelle 100, which is mounted atop a tall tower structure 102 anchored to the ground 104. The nacelle 100 rests on a yaw platform 101 and is free to rotate in the horizontal plane about a yaw pivot 106 and is maintained in the path of prevailing wind current.

The turbine has a rotor with variable pitch blades, 112, 114, attached to a rotor hub 118. The blades rotate in response to wind current. Each of the blades may have a blade base section and a blade extension section such that the rotor is variable in length to provide a variable diameter rotor. As described in U.S. Pat. No. 6,726,439, the rotor diameter may be controlled to fully extend the rotor at low flow velocity and to retract the rotor, as flow velocity increases such that the loads delivered by or exerted upon the rotor do not exceed set limits. The nacelle 100 is held on the tower structure in the path of the wind current such that the nacelle is held in place horizontally in approximate alignment with the wind current. The electric generator is driven by the turbine to produce electricity and is connected to power carrying cables inter-connecting to other units and/or to a power grid.

The apparatus shown in FIG. 1 controls the RPM of a wind turbine and damps the tower resonant motion and 3P motion. The pitch of the blades is controlled in a conventional manner by a command component, conventional pitch command logic 148, which uses generator RPM 138 to develop a nominal rotor blade pitch command signal 154. Damping logic 146 connected to the tower acceleration signal 143 generates an estimated blade pitch modulation command 152. Combining logic 150 connected to the estimated blade pitch modulation command 152 and to the pitch command 154 provides a combined blade pitch command 156 capable of commanding pitch of the rotor blades, which combined blade pitch command includes damping of the wind turbine tower resonant motion and of the 3P blade imbalance motion.

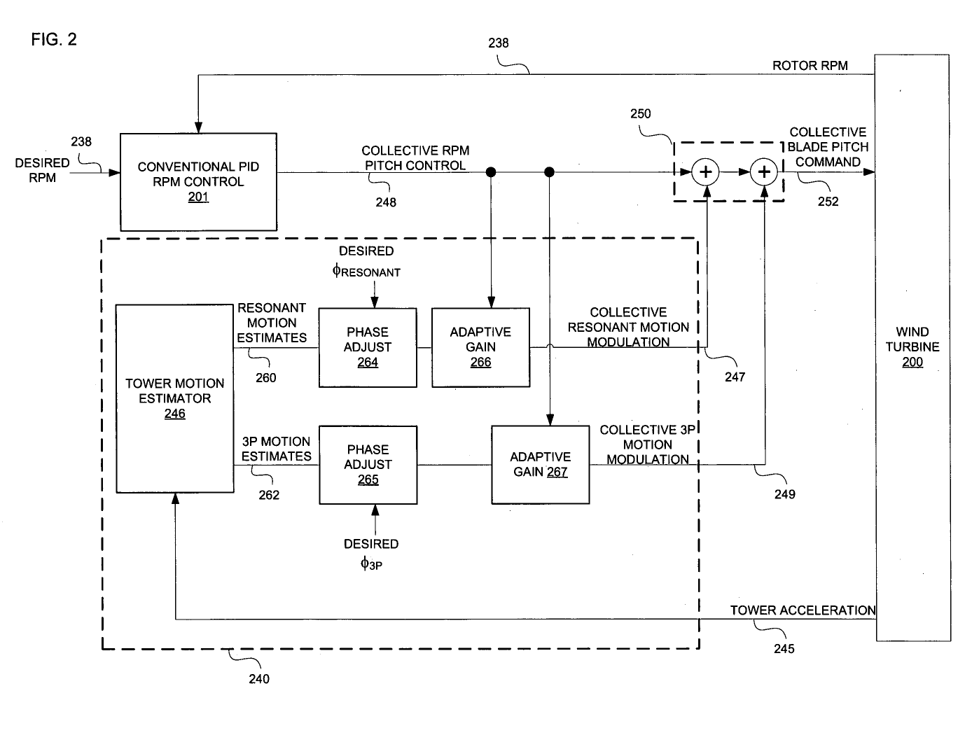

The apparatus shown in FIG. 2 compensates for tower resonance and blade imbalance in a wind turbine 200. The nominal pitch of the blades is controlled in a conventional manner 201 by a command component 248, which uses actual generator RPM 238 to develop the rotor blade pitch command signal.

The modulation of the pitch of the blades is controlled by tower-damping logic 240. The result is a collective resonant motion modulation 247 and a collective 3P motion modulation 249. Combining logic 250 connected to the blade pitch modulation commands 247 and 249 and to the collective pitch command 248, provides a combined blade pitch command 252 capable of commanding pitch of the rotor blades, which includes damping of the wind turbine tower and of the blades.

The tower damping logic 240 comprises a tower motion estimator 246 using tower acceleration measurements 245 to estimate the tower resonant motion 260 and the tower 3P motion 262. The resonant motion estimates 260 are phase-adjusted 264 and amplified by an adaptive gain 266 using the collective RPM command component 248 to select the appropriate gain. The 3P motion estimates 262 are phase-adjusted 265 and amplified by an adaptive gain 267 using the collective RPM command component 248 to select the appropriate gain.

The Estimator: The tower resonant estimator logic is based on a second order damped model of the tower resonant motion:

aᵣₑₛₒₙₐₙₜ=−ωᵣₑₛₒₙₐₙₜ²xᵣₑₛₒₙₐₙₜ−2ωᵣₑₛₒₙₐₙₜξᵣₑₛₒₙₐₙₜvᵣₑₛₒₙₐₙₜ

wherein a is acceleration (m/s/s), v is velocity (m/s), x is position (m), and ξᵣₑₛₒₙₐₙₜ is the damping coefficient of the estimator tower resonant response (not necessarily of the tower dynamics) used to tune its response, and ωᵣₑₛₒₙₐₙₜ is the known resonant frequency of that motion. Taking two derivatives with respect to time, this model is written in terms of acceleration alone as

äᵣₑₛₒₙₐₙₜ=−ωᵣₑₛₒₙₐₙₜaᵣₑₛₒₙₐₙₜ−2ωᵣₑₛₒₙₐₙₜξᵣₑₛₒₙₐₙₜ\dot{a}ᵣₑₛₒₙₐₙₜ+δᵣₑₛₒₙₐₙₜ

The added δᵣₑₛₒₙₐₙₜ term (m/s/s/s/s) is a stochastic noise quantity representing inaccuracies in the model and its standard deviation σ is used to further tune the estimator response.

The estimator is further based on a second order damped model of the 3P wind shear motion

ä_{3P}=−ω_{3P}²a_{3P}−2ω_{3P}ξ_{3P}\dot{a}_{3P}+δ_{3P}

wherein ξ_{3P} and δ_{3P} are similarly used to tune the estimator response.

The estimator uses the measurement equation relating these two accelerations to the measured acceleration

a_{measured}=aᵣₑₛₒₙₐₙₜ+a_{3P}+δₘₑₐₛᵤᵣₑₘₑₙₜ

wherein the added δₘₑₐₛᵤᵣₑₘₑₙₜ term (m/s/s) represents stochastic measurement deviations beyond that modeled and is also used to tune the estimator response. The state space representation of the complete system is

$$\frac{d }{d t} [ \begin{matrix}{a}_{resonant} \\ {\dot{a}}_{resonant} \\ {a}_{3 P} \\ {\dot{a}}_{3 P}\end{matrix} ] = \\ [ \begin{matrix}0 & 1 & 0 & 0 \\ - {ω}_{resonant}^{2} & - 2 {ξ}_{resonant} {ω}_{resonant} & 0 & 0 \\ 0 & 0 & 0 & 1 \\ 0 & 0 & - {ω}_{3 P}^{2} & - 2 {ξ}_{3 P} {ω}_{P}\end{matrix} ] [ \begin{matrix}{a}_{resonant} \\ {\dot{a}}_{resonant} \\ {a}_{3 P} \\ {\dot{a}}_{3 P}\end{matrix} ] + [ \begin{matrix}0 & 0 \\ 1 & 0 \\ 0 & 0 \\ 0 & 1\end{matrix} ] [ \begin{matrix}{δ}_{resonant} \\ {δ}_{3 P}\end{matrix} ] \\ {a}_{measured} = [ \begin{matrix}1 & 0 & 1 & 0\end{matrix} ] [ \begin{matrix}{a}_{resonant} \\ {\dot{a}}_{resonant} \\ {a}_{3 P} \\ {\dot{a}}_{3 P}\end{matrix} ] + {δ}_{measurement}$$

If the acceleration signal has a bias that may change slowly with time, it is handled by high-pass filtering the signal (at around 0.01 Hz) before feeding it to the estimator, or including a bias estimation component within the estimator.

Any number of numerical and explicit means are available to convert this to a discrete time model and from there to a discrete time estimator (e.g. Kalman filter, H_{∞}, pole placement, . . . ) generally having the form

$$\begin{matrix}{\underline{x}}_{i + 1 / i} = {\underline{Ax}}_{i / i} \\ {\underline{x}}_{i + 1 / i + 1} = {\underline{x}}_{i + 1 / i} + \underline{k} ( {a}_{measurement , i}^{*} - {\underline{cx}}_{i + 1 / i} ) \\ = {\underline{Ax}}_{i / i} + \underline{k} ( {a}_{measurement , i}^{*} - {\underline{cAx}}_{i / i} ) \\ = ( \underline{I} - \underline{kc} ) {\underline{Ax}}_{i / i} + \underline{k} {a}_{measurement , i}^{*} \\ = {\underline{Γx}}_{i / i} + \underline{k} {a}_{measurement , i}^{*}\end{matrix}$$

wherein k is the estimator gain matrix and a*_{measurement,i} is the actual acceleration measurement at time tᵢ. The gain can vary with each estimate (as in the classical Kalman or H_{∞} filters) or can be selected as a constant matrix (as in pole placement and the steady state Kalman or H_{∞} gains). Time varying gains have the advantage of adapting to changing resonant and wind shear ω and ε while constant gains have the advantage of forming a very simple and computationally efficient filter.

The two stages of the estimator, the resonant and the 3P, are formed together within the same observer. This means the design process (gain selection) produces an observer that ‘knows’ both phenomena exist and their interactions. And, because this is an estimator and thus cannot allow phase errors, the estimates have minimal phase error (generally zero error unless the frequency bandwidths substantially overlap). Further, since the both phenomena are estimated, each is free of the other.

Feedback for Tower Resonant Damping: A damping feedback term is developed to add damping to the tower resonant portion of the dynamics. A more complete model of the resonant dynamics, one that includes the affect of blade pitch and wind speed, is

äᵣₑₛₒₙₐₙₜ=−ωᵣₑₛₒₙₐₙₜ²aᵣₑₛₒₙₐₙₜ−2ωᵣₑₛₒₙₐₙₜεᵢₙₕₑᵣₑₙₜ\dot{a}ᵣₑₛₒₙₐₙₜ+fᵣₑₛₒₙₐₙₜ(β,V_{wind})+ . . .

wherein εᵢₙₕₑᵣₑₙₜ is the inherent or existing natural damping, and fᵣₑₛₒₙₐₙₜ(β, V_{wind}) is a forcing function representing the influence of blade pitch β and wind speed V_{wind} through the blade aerodynamics. If damping is added by modulating pitch, then approximately

äᵣₑₛₒₙₐₙₜ=−ωᵣₑₛₒₙₐₙₜ²aᵣₑₛₒₙₐₙₜ−2ωᵣₑₛₒₙₐₙₜ(εᵢₙₕₑᵣₑₙₜ+εₓₜᵣₐ)\dot{a}ᵣₑₛₒₙₐₙₜ+fᵣₑₛₒₙₐₙₜ(β,V_{wind})+gᵣₑₛₒₙₐₙₜ(V_{wind})Δβᵣₑₛₒₙₐₙₜ+ . . .

wherein εₓₜᵣₐ is the desired extra damping coefficient produced by the imposed Δβᵣₑₛₒₙₐₙₜ modulation. The gᵣₑₛₒₙₐₙₜ(V_{wind}) gain factor as determined from simulation studies of the turbine. Equating terms, the extra damping is provided by the modulation when the pitch modulation is scheduled by wind speed as

$${Δβ}_{resonant} = - \frac{2 {ω}_{resonant} {ξ}_{xtra}}{{g}_{resonant} ( {V}_{wind} )} {\dot{a}}_{resonant}$$

Lacking wind speed values, V_{wind} is replaced by pitch given by the steady state relation V_{windSS}=h((β_{SS}) between wind speed and pitch for the turbine:

$${Δβ}_{resonant} = - \frac{2 {ω}_{resonant} {ξ}_{xtra}}{{g}_{resonant} [ h ( β ) ]} {\dot{a}}_{resonant}$$

The feedback pitch is a modulation to the pitch demand normally produced by the turbine for its other control functions (e.g. rpm control using PID compensators). Since the feedback is based only on the resonant motion estimation, and this is free of 3P dynamics, the feedback has no undesired frequencies and does not exacerbate turbine blade modes.

Phase Control: It is one thing to demand a pitch and quite another to get a response. Pitch actuators and other processing requirements add lag between the demand and the actuation, and this can be corrected by adding lead to the demand modulation. Simplifying the estimator resonant dynamics by ignoring damping terms:

äᵣₑₛₒₙₐₙₜ=−ωᵣₑₛₒₙₐₙₜ²aᵣₑₛₒₙₐₙₜ

At steady state the complex exponential solution is

aᵣₑₛₒₙₐₙₜ(jωᵣₑₛₒₙₐₙₜ)=λe^{jω}^{ᵣₑₛₒₙₐₙₜ}

\dot{a}ᵣₑₛₒₙₐₙₜ(jωᵣₑₛₒₙₐₙₜ)=jωᵣₑₛₒₙₐₙₜλe^{jω}^{ᵣₑₛₒₙₐₙₜ}

If the phase shifted term is formed by a unity gain sum of \dot{a}ᵣₑₛₒₙₐₙₜ and aᵣₑₛₒₙₐₙₜ as

$${\dot{a}}_{resonant} {\_}_{phaseShifted} = \frac{{γω}_{resonant} {a}_{resonant} + {\dot{a}}_{resonant}}{\sqrt{1 + {γ}^{2}}}$$

then using Euler's equation

$$\begin{matrix}{\dot{a}}_{resonant} {\_}_{phaseShifted} ( {jω}_{resonant} ) = {\dot{a}}_{resonant} ( {jω}_{resonant} ) \frac{1 - γj}{\sqrt{1 + {γ}^{2}}} \\ = {\dot{a}}_{resonant} ( {jω}_{resonant} ) {e}^{{jφ}_{resonant}} \\ = {\dot{a}}_{resonant} ( {jω}_{resonant} ) \\ ( cos {φ}_{resonant} + jsin {φ}_{resonant} )\end{matrix}$$

wherein φᵣₑₛₒₙₐₙₜ is the desired phase shift (positive for lead). Equating real and imaginary terms,

$$\begin{matrix}cos φ = \frac{1}{\sqrt{1 + {γ}^{2}}} \\ sin φ = - \frac{γ}{\sqrt{1 + {γ}^{2}}} \\ {\dot{a}}_{resonant} {\_}_{phaseShifted} = \frac{{\dot{a}}_{resonant} - ( {ω}_{resonant} tan {φ}_{resonant} ) {a}_{resonant}}{\sqrt{1 + {tan}^{2} {φ}_{resonant}}} \\ = - ( {ω}_{resonant} sin {φ}_{resonant} ) {a}_{resonant} + \\ ( cos {φ}_{resonant} ) {\dot{a}}_{resonant}\end{matrix}$$

The phase controlled pitch modulation is then given by

$${Δβ}_{resonant \_ phaseShifted} = - \frac{2 {ω}_{resonant} {ξ}_{xtra}}{{g}_{resonant} [ h ( β ) ]} [ \begin{matrix}- ( {ω}_{resonant} sin {φ}_{resonant} ) {a}_{resonant} + \\ ( cos {φ}_{resonant} ) {\dot{a}}_{resonant}\end{matrix} ]$$

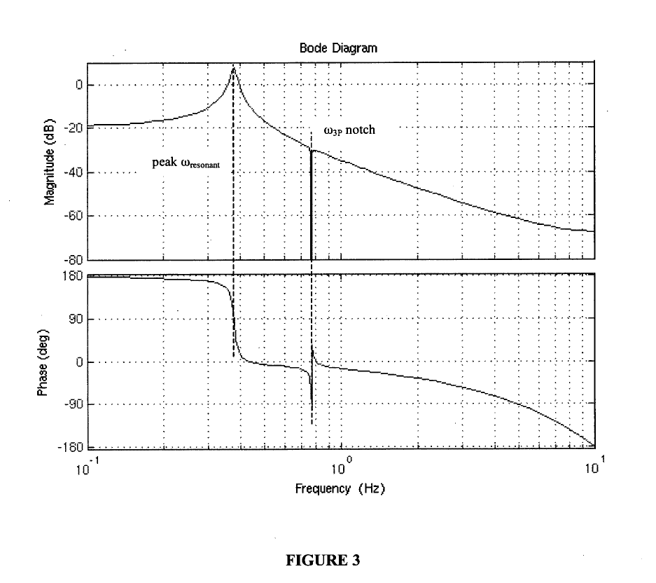

Example of Tower Resonant Damping: Consider a turbine having tower resonance frequency of 0.38 Hz, blade bending moment close to the 3P frequency, and a 20 Hz control loop. At rated rpm (15.5 rpm) 3P is at 0.775 Hz and must be eliminated from the modulated pitch feedback so as not to exacerbate blade bending. Using preliminary values
εₓₜᵣₐ=0.707
σ_{δmeasurement}=0.1
φ=0
ωᵣₑₛₒₙₐₙₜ=2π(0.38)
ωᵣₑₛₒₙₐₙₜ2π(0.775)
σ_{δresonant}=0.001
εᵣₑₛₒₙₐₙₜ=0
σ_{δ3P}=0.001
ε_{3P}=0
   the state space model is digitized (using the Tustin, or bilinear, transform), the steady state Kalman gains are calculated, and the Bode plot (using zero-order-hold) of the acceleration measurement to \dot{a}ᵣₑₛₒₙₐₙₜ, shown in FIG. 3, has a peak at ωᵣₑₛₒₙₐₙₜ and a notch at ω_{3P}.

Although a dynamic Kalman filter is useful to track the 3P frequency as the turbine changes rpm, here the steady state is considered as it is computationally simpler and has been shown to work well.

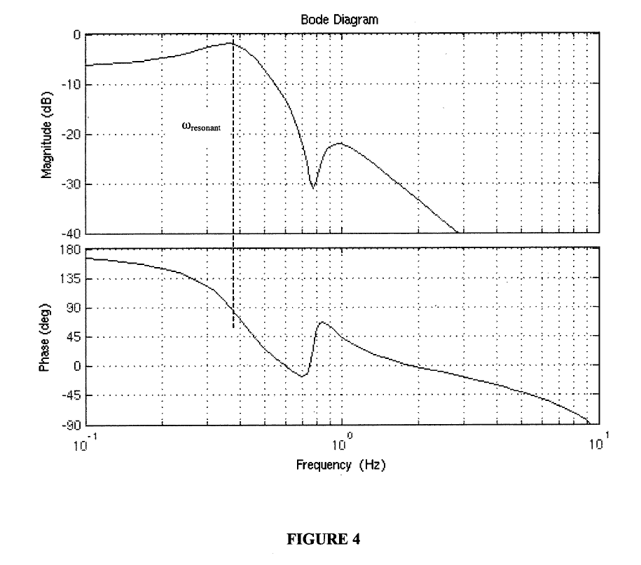

Increasing σ_{δresonant} and σ_{δ3P} to widen the bandwidth of the peak and notch, since the resonant and 3P frequencies are not that well known, and increasing εᵣₑₛₒₙₐₙₜ and ε_{3P} to soften the response:
σ_{δresonant}=0.016
εᵣₑₛₒₙₐₙₜ=0.2
σ_{δ3P}=0.04
   produces the Bode plot of FIG. 4. Notice, in both FIG. 3 and FIG. 4, that the phase of the resonant signal at ω_{damp} is +90 degrees as expected of a differentiator, and without error. The resulting estimator matrices are

$${\underline{Γ}}_{ss} = [ \begin{matrix}0.96833 & 0.047412 & - 0.023486 & - 0.0011803 \\ - 0.30196 & 0.94372 & 0.0048336 & 0.00024292 \\ - 0.090436 & - 0.0044280 & 0.88257 & 0.044354 \\ - 0.14511 & - 0.0071052 & - 1.2992 & 0.94492\end{matrix} ]$$

$${\underline{k}}_{ss} = [ \begin{matrix}0.024186 \\ - 0.0049776 \\ 0.091135 \\ 0.14624\end{matrix} ]$$

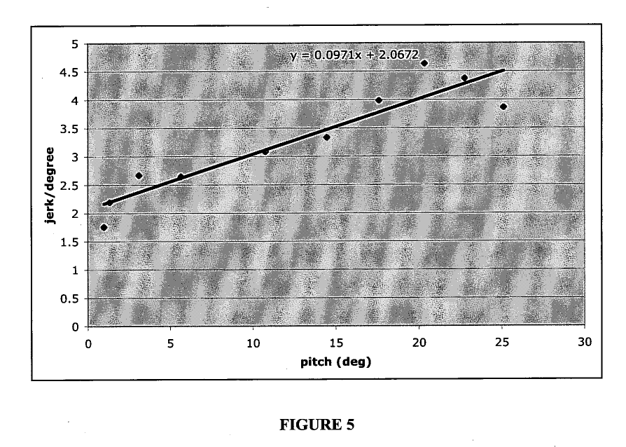

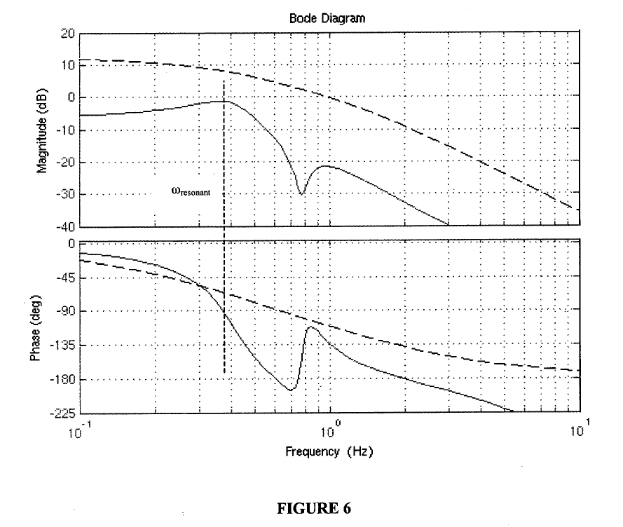

Simulation studies of the turbine produce gᵣₑₛₒₙₐₙₜ[h(β)], the gain scheduling term, shown in FIG. 5, with the resulting Bode plot of the pitch modulation of FIG. 6. Also shown in FIG. 6 is the conventional band-pass compensator originally developed for this turbine (dashed lines). Whereas the original system exacerbated blade bending, the estimator does not and produces equivalent tower resonant damping.

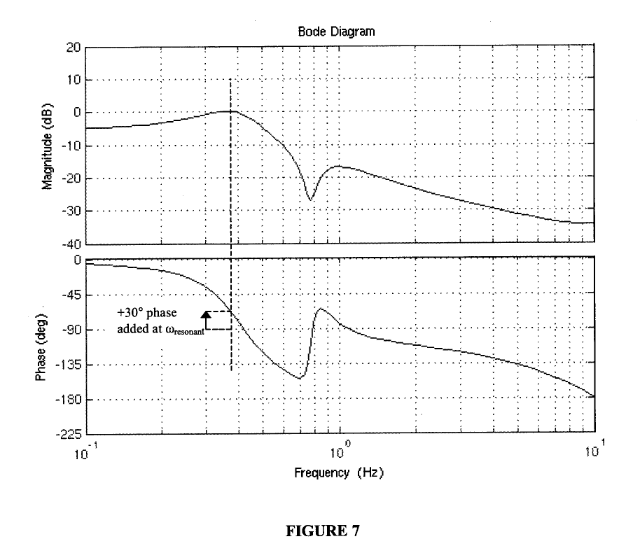

To illustrate the phase shifting property, increasing
φ=30 degrees
   produces the Bode of FIG. 7 where the +30 degree phase shift at ωᵣₑₛₒₙₐₙₜ is seen when compared to FIG. 6.

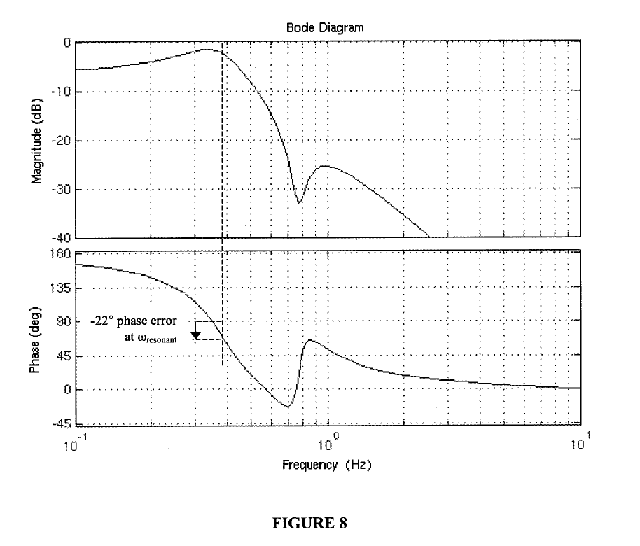

Attempts to produce the transfer function of FIG. 4 using conventional frequency filters is not successful. FIG. 8 is the result of using a low-pass followed by a notch filter:

$$lowPass ( s ) = {g}_{low} \frac{{ω}_{resonant}^{2}}{{s}^{2} + 2 {ξ}_{low} s + {ω}_{resonant}^{2}}$$

$$notch ( s ) = 1 - {g}_{notch} \frac{{ω}_{3 P}^{2}}{{s}^{2} + 2 {ξ}_{notch} s + {ω}_{3 P}^{2}}$$

with
g_{low}=−0.5
ε_{low}=0.3
g_{notch}=0.85
ε_{notch}=0.3
   Although the magnitude plot is similar, the phase is not: there is an added 22 degree phase lag at ωᵣₑₛₒₙₐₙₜ in contrast to the estimator of FIG. 4.

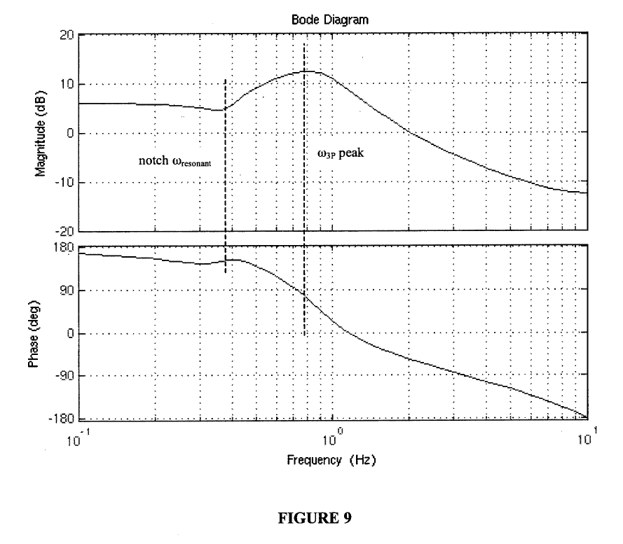

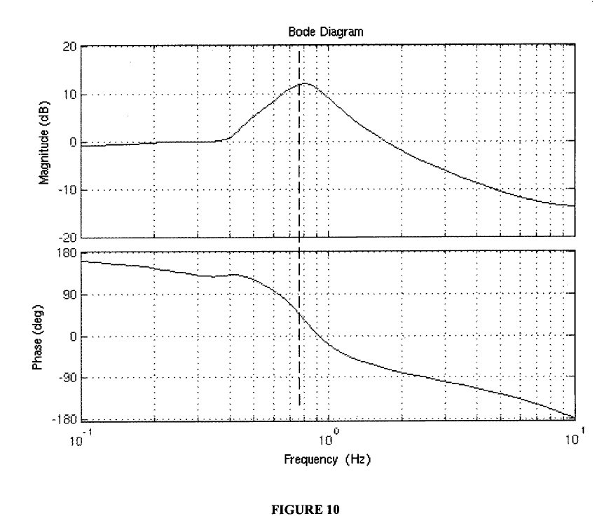

Feedback for Tower 3P Damping Plus Phase Control: Identically as for the resonant damping above, the 3P tower motion damping is given by

$${\dot{a}}_{3 P\_phaseShifted} = - ( {ω}_{3 P} sin {φ}_{3 P} ) {a}_{3 P} + ( cos {φ}_{3 P} ) {\dot{a}}_{3 P}$$

$${Δβ}_{3 P \_ phaseShifted} = - \frac{2 {ω}_{3 P} {ξ}_{xtra}}{{g}_{3 P} [ h ( β ) ]} {\dot{a}}_{3 {P}_{3 P \_ phaseShifted}}$$

wherein the 3P acceleration terms are taken directly from the estimator values and g_{3P}[h(β)] is determined from simulation studies. The transfer function from tower acceleration to \dot{a}_{3P} is shown in FIG. 9: there is a notch at ωᵣₑₛₒₙₐₙₜ and a peak at ω_{3P} with the anticipated +90 degree phase shift of a differentiator. The phase actually slightly less than 90 degrees due to lag introduced at ω_{3P} by the nature of zero-order-holds of sampled data systems (added lag=0.775 Hz*360 degrees/20 Hz=14 degrees). Phase control is important so as not to exacerbate blade bending while damping it. As seen in FIG. 6, the conventional design that exacerbated blade bending produced a 3P feedback component having a phase of around −98 degrees. With the negative sign used on the feedback gain, the nominal estimator feedback is close at −90+14=−76 degrees and needs to be adjusted to damp and not excite the blade bending mode. FIG. 10 illustrates the added 30 degree lag when φ_{3P}=−30 degrees.

### Other Embodiments

While the invention has been particularly shown and described with reference to preferred embodiments thereof, it will be understood by those skilled in the art that the foregoing and other changes in form and detail may be made therein without departing from the scope of the invention. Whereas the steady state estimator gains have been used for illustrative purposes, the dynamic gains adapting to rotor rpm are included in this invention. Whereas the tower resonant and 3P frequencies have been used for illustrative purpose, other frequencies are considered. Whereas tower damping is used as an illustrative example, the invention can be used for other applications such as rotor damping and to remove undesired frequencies from such signals as rotor rpm and so forth.

What is claimed is:

1. An apparatus that damps unwanted frequencies in a wind turbine tower comprising:
a rotor blade pitch command signal;
tower damping logic comprising motion estimates using tower acceleration measurements;
an output of said tower damping logic comprising a collective motion modulation based on said motion estimates; and,
combining logic connected to said tower damping logic and to said pitch command, an output of said combining logic being a combined blade pitch command capable of commanding pitch of the rotor blades, which includes damping of said wind turbine tower.

2. The apparatus of claim 1 wherein said collective motion modulation includes one or more of tower resonant motion and an unwanted frequency motion.

3. The apparatus of claim wherein said motion estimates include one or more of resonant motion estimates and unwanted frequency motion estimates.

4. A method of using tower acceleration measurements to damp tower resonance motion, while also suppressing unwanted signals in the measurements, in a wind turbine tower which uses a pitch command to control pitch of rotor blades of said wind turbine, comprising steps of:
A. measuring tower acceleration;
B. estimating the tower resonant motion and the unwanted motion using the acceleration measurements
C. providing a blade pitch resonant command to damp tower motion using said tower resonant motion estimates;
D. combining said blade pitch resonant command with said pitch command resulting in a combined pitch command; and
F. using said combined pitch command to control pitch of the rotor blades in order to damp said wind turbine tower.

5. The method of claim 4 further comprising:
C. providing a blade pitch unwanted command to damp the unwanted motion using said unwanted motion estimates; and,
D. combining the blade pitch unwanted command to form the combined pitch command.
